(19) United States
(12) Patent Application Publication
(10) Pub. No.: US 2026/0030110 A1
(43) Pub. Date: Jan. 29, 2026

(54) SYSTEM CONTEXT AWARE SELF-HEALING METHOD FOR SYSTEM FAILURES

(71) Applicant: Dell Products L.P., Round Rock, TX (US)

(72) Inventors: Jagadish Babu JONNADA, Leander, TX (US); Ibrahim SAYYED, Georgetown, TX (US); Adolfo S. MONTERO, Pflugerville, TX (US)

(73) Assignee: Dell Products L.P., Round Rock, TX (US)

(21) Appl. No.: 18/787,344

(22) Filed: Jul. 29, 2024

(51) Int. Cl. G06F 11/14; G06F 9/4401

(52) U.S. Cl. CPC G06F 11/1417; G06F 9/4401; G06F 2201/86

(57) ABSTRACT

An information handling system may include at least one processor; a memory; a Basic Input/Output System (BIOS); and an embedded controller. The embedded controller may be configured to: collect information regarding a boot process of the information handling system; determine, based on the collected information, that a boot loop event has occurred; and apply a remediation to the information handling system to prevent the boot loop event from recurring.

### TECHNICAL FIELD

The present disclosure relates in general to information handling systems, and more particularly to recovery from system failures that may cause problems in booting.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may occasionally experience a critical failure that prevents it from booting successfully. Sometimes such failures result in the system repeatedly attempting to power cycle and reboot, but never succeeding (known as a boot loop).

In other cases, the failure may cause the system to shut down (e.g., to a soft-off state such as S5 or a power-off state such as G3). Failures that cause the system to shut down may also result in a boot loop, however, due to the presence of a watchdog timer in the system's SoC or embedded controller, which may trigger an automatic restart of the system in the event of an abnormal shutdown. Sometimes system failures may occur prior to initialization of an operating system (OS), during execution of the BIOS code. Before OS initialization, failures are typically based on causes such as hardware and firmware defects. After the OS has booted, failures may also be based on the additional complexity of the OS environment and/or its interaction with the BIOS. For example, due to a conflict between the OS system files or corruption in those files, the system may shut down abruptly, leading to boot failures and other side-effect issues. Debugging these issues is complex, because they can be caused by a hardware (e.g., SoC) problem, a firmware problem, an OS problem, or an OS/BIOS interaction problem.

Embodiments of this disclosure provide a hardware-agnostic, OS-agnostic technique to detect such scenarios and recognize abnormal behavior leading to potential failure conditions. Embodiments may be used to configure the system for automatic self-healing tasks to prevent the failure from recurring and/or recover from it.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with critical system boot failures may be reduced or eliminated.

In accordance with embodiments of the present disclosure, an information handling system may include at least one processor; a memory; a Basic Input/Output System (BIOS); and an embedded controller. The embedded controller may be configured to: collect information regarding a boot process of the information handling system; determine, based on the collected information, that a boot loop event has occurred; and apply a remediation to the information handling system to prevent the boot loop event from recurring.

In accordance with these and other embodiments of the present disclosure, a method may include, in an information handling system including a Basic Input/Output System (BIOS) and an embedded controller: the embedded controller collecting information regarding a boot process of the information handling system; the embedded controller determining, based on the collected information, that a boot loop event has occurred; and the embedded controller applying a remediation to the information handling system to prevent the boot loop event from recurring.

In accordance with these and other embodiments of the present disclosure, an article of manufacture may include a non-transitory, computer-readable medium having computer-executable instructions thereon that are executable by an embedded controller of an information handling system, wherein the information handling system includes a Basic Input/Output System (BIOS) and the embedded controller, the instructions being executable for: collecting information regarding a boot process of the information handling system; determining, based on the collected information, that a boot loop event has occurred; and applying a remediation to the information handling system to prevent the boot loop event from recurring.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an example method for detecting and remediating a boot loop event, in accordance with embodiments of the present disclosure; and

FIG. 3 illustrates an example method for detecting and remediating a boot loop event, in accordance with embodiments of the present disclosure.

### DETAILED DESCRIPTION

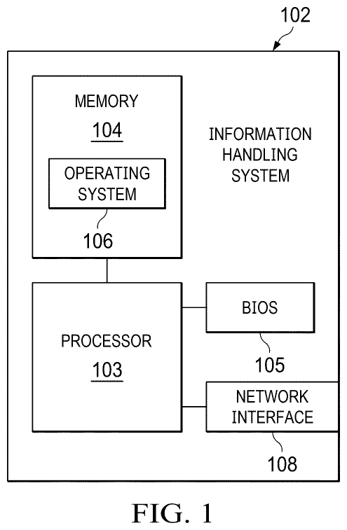

Preferred embodiments and their advantages are best understood by reference to FIGS. 1 through 3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may executable instructions (or comprise any program of aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Information handling system 102 may also include an embedded controller (EC) for carrying out various low-level tasks (e.g., keyboard processing, power management, lighting controls, etc.). The EC may include a processor such as a microcontroller, one or more storage elements, etc. The EC may be coupled to the host processor of information handling system 102 via a communications link such as I2C, serial peripheral interface (SPI), etc.

As discussed above, information handling system 102 may experience a critical failure that renders it unable to boot successfully, which may lead to a boot loop event.

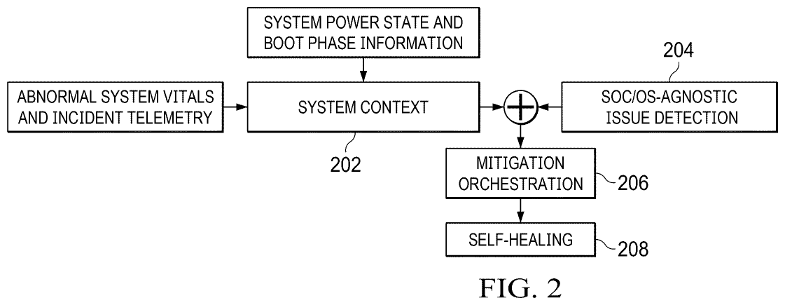

FIG. 2 illustrates an example framework which may be used to detect and mitigate such failures. At a high level, embodiments may include two main components: (1) hardware-based issue detection to implement a model to recognize abnormal behavior and potential failures based on system state and context; and (2) self-healing orchestration based on the detected symptoms.

The issue detection model may be implemented as an AI model in some cases, and it may be trained on a corpus of existing telemetry data regarding prior issues in the same and/or other information handling systems. In other embodiments, the model may be a statistical model that is not based on AI techniques.

As shown in FIG. 2, system context 202 may incorporate information such as the system power state (e.g., S0-S5 states) and the boot phase at the time of failure (e.g., the various phases of UEFI boot such as power-sequencing, SEC, PEI, DXE, BDS, hand-off, OS start-up, OS runtime, etc.). System context 202 may also include information about abnormal system vitals (e.g., issues such as fan failure, thermal problems, hardware changes, etc.) and telemetry about prior issues the system has experienced.

System context 202 may then be combined with issue detection 204, which may incorporate information about detected boot looping, automatic shutdowns, BIOS corruption, SoC crashes, OS crashes, etc.

As discussed herein, the result of this combination may lead to mitigation orchestration 206 and a determination of the steps needed to perform self-healing operations 208. For example, such operations may include performing a power flush, a flash recovery, a memory and/or SSD healing operation, a real-time clock reset, a repair of a SPI data storage element, a factory reset of a particular component, a firmware reset of a particular component, an OS recovery, etc.

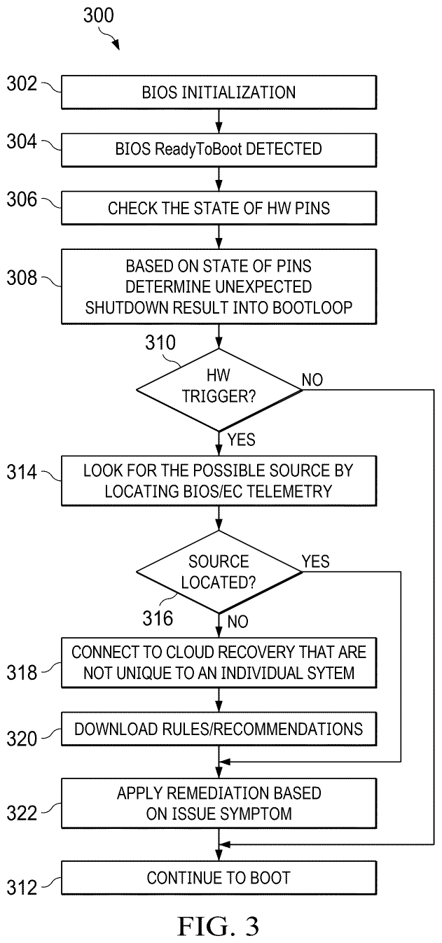

FIG. 3 illustrates a flowchart of one embodiment of a method 300 for performing issue detection such as illustrated schematically in the issue detection 204 block. Method 300 may be used to flag an auto-shutdown event and create a detailed log of the most relevant and critical telemetry markers. Detection steps taking place within the host CPU context may be transmitted to the EC for storage in the EC's nonvolatile memory, while detection steps taking place within the EC itself may be logged by the EC. In some embodiments, the information may then be transmitted by the EC to a cloud-based monitoring system via an EC-accessible sideband network.

The example implementation of method 300 illustrates the situation where processor 103 is an Intel SoC. One of ordinary skill in the art with the benefit of this disclosure will appreciate that similar steps may be applied in the case of an ARM (or other) SoC, with appropriate modifications to the different registers, hardware control points, etc.

At steps 302 and 304, the system BIOS is initialized and reaches the ReadyToBoot( ) stage.

At step 306, the system may check the status of various hardware pins for evidence of a hardware issue. For example, the ESPI_RST# signal may be an indicator of a global reset at the level of the platform controller hub (PCH). The system may also check for VCCST_PWRGD toggles as an indicator of a cold reset, and check if only PLT_RST# has been toggled, indicating a warm reset.

For PCH-initiated resets, the typical trigger register values may be captured to determine the source of a register write that may have caused the reset. Further, an active Thermtrip# signal and/or a BIOS event log entry or other log entry for a “thermal trip” or similar event may be checked, as well as any SoC registers indicating that it self-protected from an over-temperature condition.

If no hardware trigger is detected at step 310, then the system may proceed to a normal boot at step 312.

If a hardware trigger event is present, then at step 314, the system looks for possible sources by inspecting telemetry available via the BIOS and/or EC. For example, events such as a flash update, a recovery procedure, a device firmware update, a new hardware component, an OS software update, or various logged system events may point to a cause. If the source is not located via this telemetry, then at steps 316-320, the EC may upload the data into a cloud system (e.g., another information handling system connected via the internet, typically operated by a manufacturer or vendor of the information handling system) and check for an updated remediation scheme based on the system's model information and the telemetry data. The cloud system may contain issue resolution heuristics continuously updated by following developing patterns of issue diagnosis.

In either case, the remediation may then be applied at step 322, and the boot process may continue. Results of the remediation (e.g., the steps taken and whether or not they were successful) may then also be uploaded to the cloud system to inform future recommendations.

One of ordinary skill in the art with the benefit of this disclosure will understand that the preferred initialization point for the methods depicted in FIGS. 2 and 3 and the order of the steps comprising those methods may depend on the implementation chosen. In these and other embodiments, these methods may be implemented as hardware, firmware, software, applications, functions, libraries, or other instructions. Further, although FIGS. 2 and 3 disclose a particular number of steps to be taken with respect disclosed methods, the methods may be executed with greater or fewer steps than depicted. The methods may be implemented using any of the various components disclosed herein (such as the components of FIG. 1), and/or any other system operable to implement the methods.

In general, boot looping may be triggered by an auto-reboot event occurring during any phase of the boot process (e.g., during a BIOS phase, during execution of the main OS, and/or during execution of a recovery OS), and remediations may differ based on the phase. In some embodiments, the EC may track the various boot phases, acting as a central control point to allow coverage of boot loop situations across the various heterogeneous hardware/software/firmware layers.

If an auto-reboot occurs within the BIOS execution before booting to the main OS, the EC's progress indicators may come directly from the BIOS. If an auto-reboot occurs within the OS, the progress indicators to the EC may come through ACPI hooks for various notification events through the OS boot process.

In some embodiments, a driver may be injected into the OS that functions similarly to a code profiling tool, tracking the boot progress through the OS boot flow and transmitting information to keep the EC updated on the progress markers.

One embodiment allows for detection of a boot loop through such boot progress telemetry that has been logged across the various stages of the boot flow. Telemetry may also be tracked in the cloud to determine statistical patterns on developing hot spots and determine appropriate remediation countermeasures deployed through the cloud back to the EC to apply on the failing systems.

The EC-maintained boot counters may record statistics on boot loop event counts and trigger remediation methods as dictated by the cloud system. For example, a time stamp associated with each boot event may be determined. If the difference between subsequent boot timestamps is less than a threshold value, then a counter may be incremented indicating a possible boot loop. If the boot counter indicates that more than a threshold number of reboots have occurred within a particular period of time, then this may be taken as an indication that a boot loop event is occurring.

An active feedback loop with the cloud may improve the remediation actions based on what is found to be working or not working as remediation attempts. Once a successful remediation attempt is found, it may be marked as such in the cloud to deploy to other systems failing at the same progress indicator mark.

In some embodiments, remediation attempts may proceed in order of increasing complexity/burden until the boot loop issue is addressed. For example, one embodiment may begin by performing BIOS-based remediations such as running an auto-healing process on the memory modules and/or hard drive. If this does not fix the problem, the method may proceed to perform a BIOS update.

If these BIOS-based remediations are unsuccessful, the method may proceed to booting to a service OS and performing a repair of the main OS. As a last resort, OS recovery may be attempted to revert the system to the last known working image restore point.

All of the solution metrics may be uploaded to the cloud when the cloud does not yet have a recorded remediation for the particular system model in question.

Otherwise, when the cloud already has a recorded remediation for the issue, that method may be attempted as the very first step. In the case that the cloud did not have a previous remediation and an attempted solution in the flow shown works, then that flow may be noted as a working remediation in the cloud system for issues that are not unique to an individual system.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution,

Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor;
a memory;
a Basic Input/Output System (BIOS); and
an embedded controller;
wherein the embedded controller is configured to:
collect information regarding a boot process of the information handling system;
determine, based on the collected information, that a boot loop event has occurred; and
apply a remediation to the information handling system to prevent the boot loop event from recurring.

2. The information handling system of claim 1, wherein the BIOS is a Unified Extensible Firmware Interface (UEFI) BIOS.

3. The information handling system of claim 1, wherein the boot loop event is associated with execution of a phase of the BIOS.

4. The information handling system of claim 1, wherein the boot loop event is associated with execution of an operating system (OS) of the information handling system.

5. The information handling system of claim 1, wherein the embedded controller is further configured to:
transmit, to a cloud-based system, information regarding the boot loop event; and
receive, from the cloud-based system, information regarding the remediation.

6. The information handling system of claim 1, wherein the boot loop event comprises: an automatic shutdown event, and an automatic restart event triggered by a watchdog timer.

7. A method comprising, in an information handling system including a Basic Input/Output System (BIOS) and an embedded controller:
the embedded controller collecting information regarding a boot process of the information handling system;
the embedded controller determining, based on the collected information, that a boot loop event has occurred; and
the embedded controller applying a remediation to the information handling system to prevent the boot loop event from recurring.

8. The method of claim 7, wherein the BIOS is a Unified Extensible Firmware Interface (UEFI) BIOS.

9. The method of claim 7, wherein the boot loop event is associated with execution of a phase of the BIOS.

10. The method of claim 7, wherein the boot loop event is associated with execution of an operating system (OS) of the information handling system.

11. The method of claim 7, wherein the embedded controller is further configured to:
transmit, to a cloud-based system, information regarding the boot loop event; and
receive, from the cloud-based system, information regarding the remediation.

12. The method of claim 7, wherein the boot loop event comprises: an automatic shutdown event, and an automatic restart event triggered by a watchdog timer.

13. An article of manufacture comprising a non-transitory, computer-readable medium having computer-executable instructions thereon that are executable by an embedded controller of an information handling system, wherein the information handling system includes a Basic Input/Output System (BIOS) and the embedded controller, the instructions being executable for:
collecting information regarding a boot process of the information handling system;
determining, based on the collected information, that a boot loop event has occurred; and
applying a remediation to the information handling system to prevent the boot loop event from recurring.

14. The article of claim 13, wherein the BIOS is a Unified Extensible Firmware Interface (UEFI) BIOS.

15. The article of claim 13, wherein the boot loop event is associated with execution of a phase of the BIOS.

16. The article of claim 13, wherein the boot loop event is associated with execution of an operating system (OS) of the information handling system.

17. The article of claim 13, wherein the embedded controller is further configured to:
transmit, to a cloud-based system, information regarding the boot loop event; and
receive, from the cloud-based system, information regarding the remediation.

18. The article of claim 13, wherein the boot loop event comprises: an automatic shutdown event, and an automatic restart event triggered by a watchdog timer.
